(19) United States
(12) Patent Application Publication
(10) Pub. No.: US 2005/0161114 A1
(43) Pub. Date: Jul. 28, 2005

(54) Tool and method for protecting wood during woodworking operations

(76) Inventor: Bradley Arlen Didion, Washington, MO (US)

Correspondence Address: MARTIN & ASSOCIATES, LLC, P O BOX 548, CARTHAGE, MO, 64836-0548, US

(21) Appl. No.: 10/765,429

(22) Filed: Jan. 27, 2004

(51) Int. Cl. B27C 1/00

(52) U.S. Cl. 144/154.5

(57) ABSTRACT

A tool prevents the marring of wood during woodworking operations. The tool includes one or more flat portions with one or more slots and one or more holes. When an operation that might result in marring the wood needs to be performed, a flat portion is brought in proximity to the area where the woodworking operation is to be performed, and is laid atop the wood to protect the wood in the area of the woodworking operation. If a tool slips towards the protected area of wood, the tool will make contact with the tool. The tool disperses the force of the tool, thereby preventing the wood from being marred.

### BACKGROUND OF THE INVENTION

1. Technical Field

This invention generally relates to woodworking, and more specifically relates to ways to protect wood during woodworking operations.

2. Background Art

Wood is an indispensable product in construction, furniture, and a variety of other applications. Working with wood necessarily requires a variety of different steps, such as planing, sawing, sanding, routing, shaping, gluing, drilling, nailing, screwing, etc. These are referred to herein as “woodworking operations”. Some woodworking operations such as drilling, nailing and screwing pose a threat to marring the wood if the operation is not done perfectly. For example, when drilling, a drill bit may wander when first engaging the wood, resulting in a marred path where the drill bit wanders and a hole in the wrong location. When pounding a nail, the hammer head may slip off the head of the nail and strike the wood surface, marring the wood. When setting a finish nail, the nail set may slip off the head of the finish nail, punching a small hole in the wood surface next to the nail. When driving a screw, the tip of the screwdriver may slip off the head of the screw, resulting in the screwdriver tip marring the wood. When pulling a nail, the claw of a hammer may mar the wood near the nail head. When a skilled carpenter does these operations day in and day out, it is inevitable that even the most skilled craftsman will occasionally mar wood. Without a way to protect the surface of the wood during woodworking operations, the woodworking industry will continue to suffer from mars (or blemishes) to wood surfaces due to inadvertent mishaps while working the wood.

### DISCLOSURE OF INVENTION

A tool prevents the marring of wood during woodworking operations. The tool includes one or more flat portions with one or more slots and one or more holes. When an operation that might result in marring the wood needs to be performed, a flat portion is brought in proximity to the area where the woodworking operation is to be performed, and is laid atop the wood to protect the wood in the area of the woodworking operation. If a tool slips towards the protected area of wood, the tool will make contact with the tool. The tool disperses the force of the tool, thereby preventing the wood from being marred.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a top view of a first configuration for a tool in accordance with the preferred embodiments;

FIG. 2 is a side view of the tool in FIG. 1 taken along the line 2-2;

FIG. 3 is a side view of the tool in FIG. 1 taken along the line 3-3;

FIG. 4 is a left end view of the tool in FIG. 1 taken along the line 4-4;

FIG. 5 is a right end view of the tool in FIG. 1 taken along the line 5-5;

FIG. 6 is a top view of a second configuration for a tool in accordance with the preferred embodiments;

FIG. 7 is a side view of the tool in FIG. 6 taken along the line 7-7;

FIG. 8 is a flow diagram of a method for using the tool of the preferred embodiments;

FIG. 9 is a top view of a piece of wood with a mark showing the location of a hole to be drilled;

FIG. 10 is a top view of the piece of wood showing how a drill bit may wander, resulting in a path of wandering and a hole in the wrong location;

FIG. 11 is a top view of a piece of wood with a mark showing the location of a hole to be drilled;

FIG. 12 is a top view of the piece of wood in FIG. 11 showing a hole of the tool being aligned with the mark on the wood;

FIG. 13 is a side view showing the drilling of the wood through the tool;

FIG. 14 is a top view of the piece of wood after the drilling operation in FIG. 13 is complete, showing a drilled hole in the correct location;

FIG. 15 is a top view of a piece of wood with a mark showing the desired location of a nail;

FIG. 16 is a side view of the piece of wood in FIG. 15 showing a hammer driving the nail;

FIG. 17 is a side view of the piece of wood in FIG. 15 showing how a hammer head may glance off of the nail when pounding the nail;

FIG. 18 is a top view of the piece of wood after the glancing hammer blow in FIG. 17 showing a mar that the hammer produced in the surface of the wood;

FIG. 19 is a side view similar to that shown in FIG. 16 with the addition of the tool that is laid atop the wood surface to be protected;

FIG. 20 is a side view similar to that shown in FIG. 17 showing how the glancing hammer blow contacts the tool instead of the wood, thereby protecting the wood during the hammering operation;

FIG. 21 is a side view of a piece of wood with a finish nail that needs to be set;

FIG. 22 is a side view of the piece of wood in FIG. 21 showing a nail set contacting the head of the finish nail;

FIG. 23 is a side view of the piece of wood in FIGS. 21 and 22 showing the nail set slipping off the head of the finish nail;

FIG. 24 is a top view of the piece of wood after the nail set slips off the head of the finish nail in FIG. 23 showing a circular indentation that results from the nail set contacting the wood;

FIG. 25 is a side view similar to that shown in FIG. 22 with the addition of the tool that is laid atop the wood surface to be protected;

FIG. 26 is a side view similar to that shown in FIG. 23 showing how the nail set contacts the tool when it slips off the nail head instead of contacting the wood;

FIG. 27 is a top view of a piece of wood with a mark showing the desired location of a screw;

FIG. 28 is a side view of the piece of wood in FIG. 28 showing a screwdriver driving in a screw;

FIG. 29 is a side view of the piece of wood in FIGS. 27 and 28, showing the screwdriver slipping off the head of the screw and contacting the wood surface;

FIG. 30 is a top view of the piece of wood after the screwdriver contacts the wood surface in FIG. 29 showing a mar in the wood caused by the screwdriver;

FIG. 31 is a side view similar to that shown in FIG. 28 with the addition of the tool that is laid atop the wood surface to be protected;

FIG. 32 is a side view similar to that shown in FIG. 29 showing how the screwdriver contacts the tool when it slips off the screw head instead of contacting the wood;

FIG. 33 is a side view of a piece of wood with a nail that needs to be removed;

FIG. 34 is a side view of the piece of wood in FIG. 33 showing the claw of a hammer engaging the nail head;

FIG. 35 is a side view of the piece of wood in FIG. 34 after the hammer has been used to pull the nail;

FIG. 36 is a top view of the piece of wood in FIG. 35 after the hammer has been used to pull the nail showing indentations caused by the head of the hammer when pulling the nail;

FIG. 37 is a side view similar to that shown in FIG. 34 with the addition of the tool that is laid atop the wood surface to be protected; and

FIG. 38 is a side view similar to that shown in FIG. 35 showing how the hammer head contacts the tool when the nail is pulled instead of contacting the wood.

### BEST MODE FOR CARRYING OUT THE INVENTION

The preferred embodiments provide a tool that is used to protect wood during woodworking operations. The tool preferably includes two portions that are substantially flat and in the same plane, connected by a middle portion that is in a higher plane than the substantially flat portions. One or both of the flat portions include one or more holes and one or more slots that extend to an edge. The tool may be laid atop an area to be protected before performing a woodworking operation. If a hammer, screwdriver, or drill bit used by a craftsman to perform a woodworking operation contacts the tool, the tool disperses the force of impact. The tool thus protects the wood from being marred during the woodworking operation.

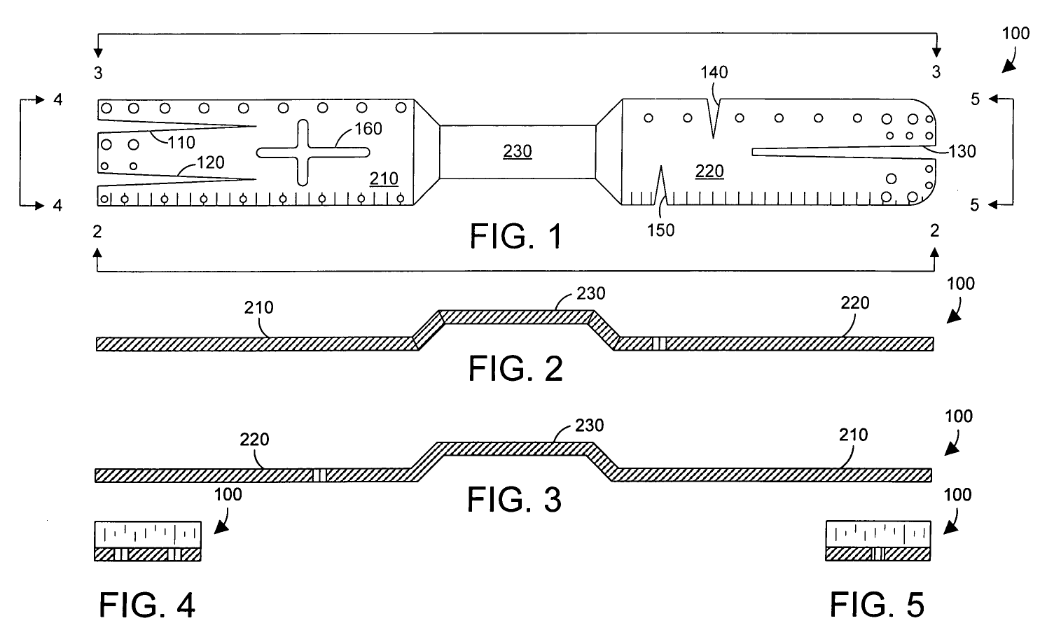

Referring to FIGS. 1-5, one specific configuration for a tool 100 in accordance with the preferred embodiments is shown. Tool 100 includes a first flat portion 210, a second flat portion 220, and a connecting middle portion 230, shown best in FIG. 2. By providing a connecting portion 230 that is above the plane of the two flat portions 210 and 220, the tool 100 provides an easy holding point for placing, positioning, and removing the tool. The tool 100 includes one or more holes and one or more slots that extend to the edge. The specific configuration shown in FIG. 1 includes multiple holes of different sizes. In addition, two slots 110 and 120 are provided on the left edge, one slot 130 is provided on the right edge, and two slots 140 and 150 are provided on the back and front edges, respectively. Note that slots 110, 120, 140 and 150 taper to a point, while slot 130 tapers to a flat edge. This provides flexibility in how the tool 100 is used. A nail, screw, or drill bit of varying sizes may be placed within any of the tapered slots. The tool may then be moved until the sides of the tapered slot engage the sides of the nail, screw or drill bit. The tapered slots shut provide a way for the tool to accommodate a wide range of sizes for nails, screws and drill bits.

Tool 100 may also include a measurement scale, shown in FIG. 1 along the bottom edge of the flat portions 210 and 220. The tool 100 may also include any suitable shape of hole or slot. For example, the tool shown in FIG. 1 includes a cross-shaped hole 160. Of course, other shapes and sizes of holes and slots are also within the scope of the preferred embodiments, which expressly extend to any and all sizes and shapes of slots or openings in a tool.

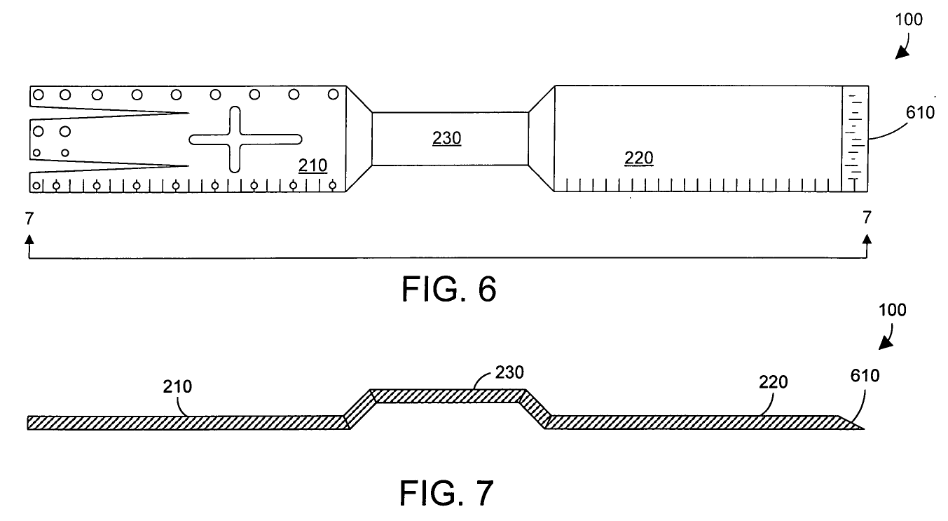

A different configuration for the tool 100 within the scope of the preferred embodiments is shown in FIGS. 6 and 7. In this configuration, only one of the two flat portions includes holes and slots. The other side has a tapered edge 610. This tapered edge could be used as a scraper, or could be used as a putty knife. The tool 100 in FIGS. 6 and 7 still includes a measurement scale on the bottom edge. The tool 100 shown in FIGS. 6 and 7 is thus very versatile and useful because it performs a variety of different functions. It may be used to protect wood during a woodworking operation, to measure, to scrape, and to putty.

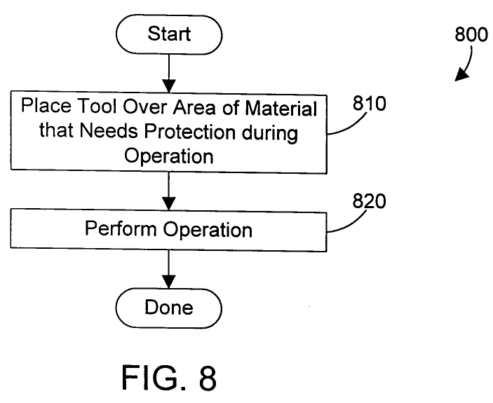

Referring to FIG. 8, a method 800 for protecting a material during an operation in accordance with the preferred embodiments begins by placing the tool over an area that needs protection during the operation (step 810). The operation is then performed (step 820) while the tool is in place, protecting the material underlying the tool. One specific example for method 800 is the protection of a piece of wood during a woodworking operation. A tool that might inadvertently contact the wood during the woodworking operation will instead contact the tool. In this manner the tool prevents the marring of wood during the woodworking operation.

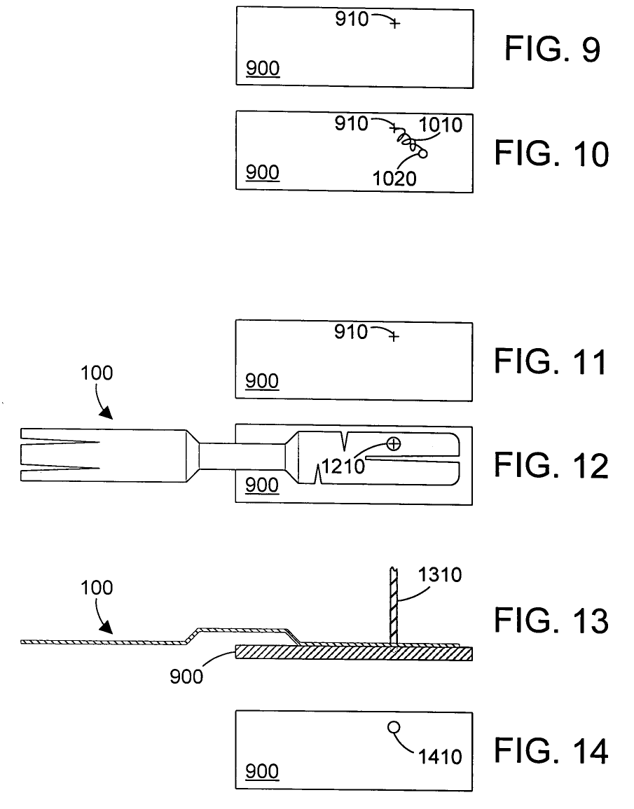

One known woodworking operation that may result in the marring of wood is drilling. FIG. 9 shows a piece of wood 900 with a mark 910 indicating where a hole needs to be drilled. Sometimes a drill bit may wander off the desired location as the hole is started. This is shown in FIG. 10, where the drill bit wanders along a path 1010 resulting in a hole 1020 that is not in the desired location. The wandering in FIG. 10 is somewhat exaggerated to illustrate the concept. But whether the drill bit wanders a little way from the desired location or a long way from the desired location, the result is a marring of the wood along the path of wandering. In addition, if the drill operator does not realize the drill bit has wandered, the drilling operation will continue, resulting in a hole 1020 that is not in the desired location.

The tool 100 may be used to prevent a drill bit from wandering during a drilling operation. FIG. 11 shows the piece of wood 900 with the mark 910 showing a desired hole location. In FIG. 12, the tool 100 is laid atop the piece of wood 910, with a hole 1210 in the tool being aligned with the mark 910, as shown. Note that only one hole 1210 is shown in FIG. 12 for the sake of clarity. Now the drill bit 1310 shown in FIG. 3 may be inserted through the hole 1210 in tool 100, and the drilling operation may be performed while holding the tool 100 in place. If the drill bit 1310 tries to wander, it will encounter the side of the hole 1210, which will keep the drill bit 1310 in the proper position. The result is a hole 1410 in the correct position, shown in FIG. 14.

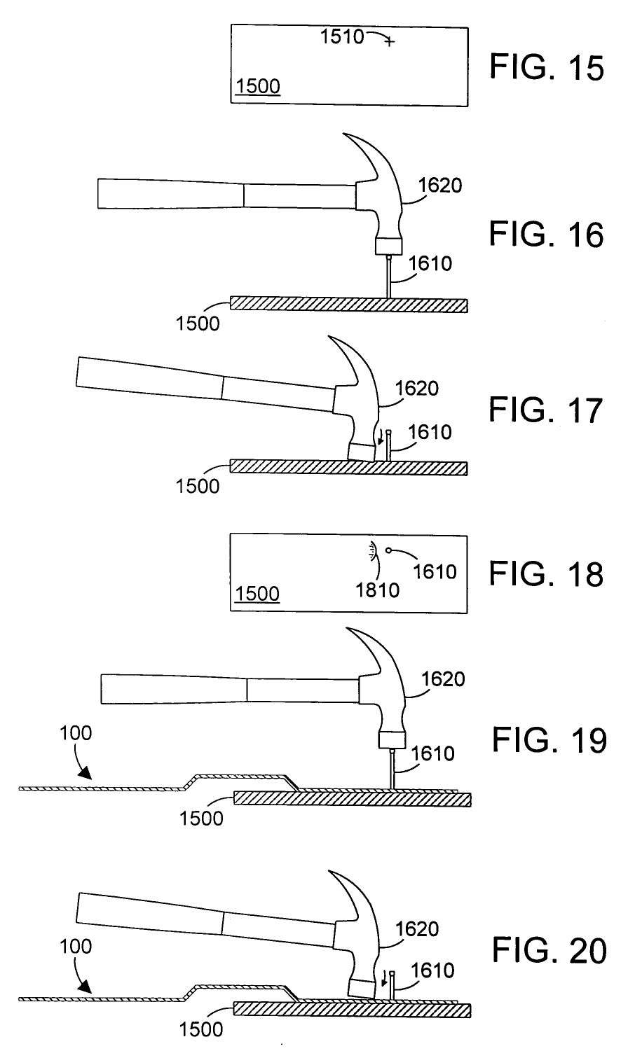

Another known woodworking operation that may result in the marring of wood is pounding in a nail. FIG. 15 shows a piece of wood 1500 with a desired nail location marked with a mark 1510. In practice, a craftsman may not actually make a mark, but will instead simply begin driving a nail in a desired location. FIG. 16 shows a finish nail 1610 being pounded into the desired location using a hammer 1620. While pounding the nail 1610, sometimes the head of the hammer 1620 may glance off the head of the nail and contact the wood surface, as shown in FIG. 17. The result is a dent in the wood in the area next to the nail, as shown by mar 1810 in FIG. 18.

The tool 100 may be used to prevent the hammer 1620 from marring the piece of wood 1500 when driving in a nail. FIG. 19 shows the piece of wood 1500 with the tool 100 laid atop the piece of wood to protect an area of wood adjacent the nailing location. Nail 160 could pass through a hole in tool 100, or could be located within a slot in tool 100. If the hammer 1620 glances off the head of the nail 1610, it will now contact the tool 100 instead of the piece of wood 1500, as shown in FIG. 20. Because the tool lies atop the wood, it protects the wood from marring by a hammer during a nail driving operation.

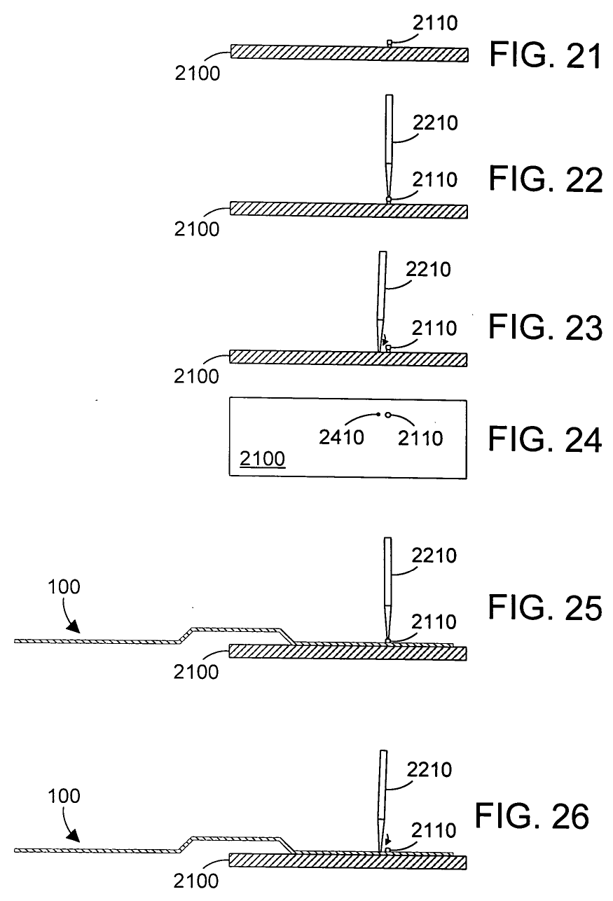

Another known woodworking operation that may result in the marring of wood is the setting of a nail. Referring to FIG. 21, a piece of wood 2100 is shown that includes a finish nail 2110 that has its head above the surface of the piece of wood 2100. It is common in finish carpentry to carefully pound a nail most of the way in, then use a nail set to drive the head of the nail below the surface of the screw. The hole left by the nail head may then be filled with putty, thereby hiding the nail head. Referring to FIG. 22, a nail set 2210 has a pointed tip that is placed atop the head of the nail 2110. A craftsman holds the nail set in place as shown in FIG. 22 with one hand, then strikes the top of the nail set with a hammer. When done properly, the nail head is driven below the surface of the wood. However, it is not uncommon for the tip of the nail set to slip off the head of the nail when the nail set is struck with a hammer, as shown in FIG. 23. The result is the nail set punches a circular indentation 2410 in the wood adjacent the nail 2110, as shown in FIG. 24. This hole caused by the nail set 2210 is a mar in the wood that now must be filled when the nail head holes are filled.

The tool 100 may be used to prevent the nail set 2210 from marring the piece of wood 2100 when setting a nail. FIG. 25 shows the piece of wood 2100 with the tool 100 laid atop the piece of wood to protect an area of wood adjacent the location of the nail head. The head of nail 2110 could pass through a hole in tool 100, or could be located within a slot in tool 100. If the nail set 2210 slips offthe head of nail 2110, as shown in FIG. 26, the tip of the nail set 2210 will now contact the tool 100 instead of the piece of wood 2100. The result is the tool 100 protects the piece of wood 2100 from marring by a nail set 2210.

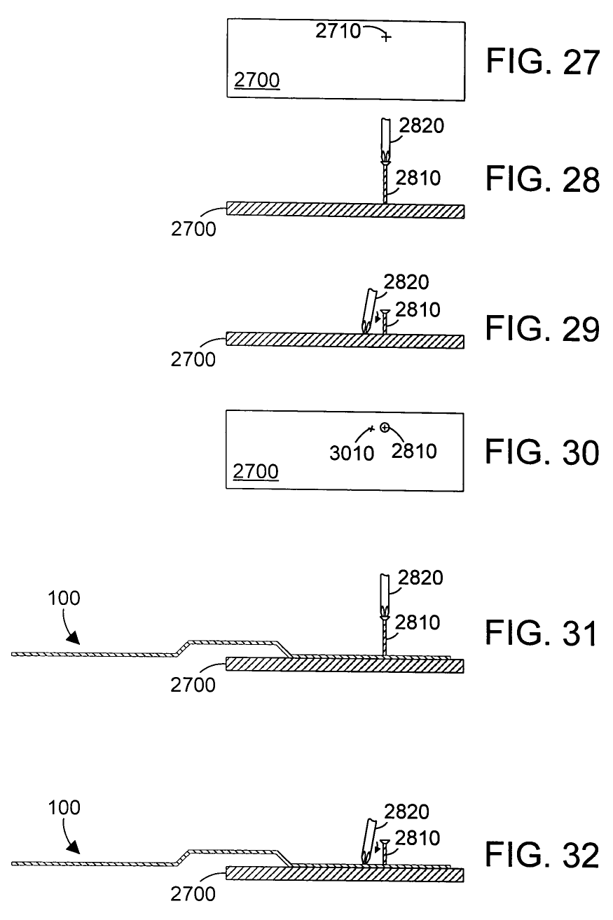

Another known woodworking operation that may result in the marring of wood is driving a screw. Referring to FIG. 27, a piece of wood 2700 is shown that includes a mark 2710 that designates the desired location of a screw. In practice, a craftsman may not actually make a mark, but will instead simply begin driving a screw in the desired location. As shown in FIG. 28, a screw 2810 may be driven in at the desired location using a screwdriver 2820. Note that screwdriver 2820 could be a normal manual screwdriver, or could be any powered driver that is capable of turning a screwdriver bit. As the screw 2810 is driven into the piece of wood 2700, sometimes the screwdriver 2820 will slip off the head of the screw 2810, as shown in FIG. 29. The result is a mar in the wood next to the screw. For a Phillips screwdriver 2820 shown in FIGS. 28 and 29, the mar will be a cross-shaped indentation 3010 in the wood, as shown in FIG. 30.

The tool 100 may be used to prevent the screwdriver 2820 from marring the piece of wood 2700 when driving a screw. FIG. 31 shows the piece of wood 2700 with the tool 100 laid atop the piece of wood to protect an area of wood adjacent the location of the screw 2810. The screw 2810 could pass through a hole in tool 100, or could be located within a slot in tool 100. If the screwdriver 2820 slips off the head of the screw 2810, as shown in FIG. 32, the tip of the screwdriver 2820 will now contact the tool 100 instead of the piece of wood 2700. The result is the tool 100 protects the piece of wood 2700 from marring by a screwdriver 2820. While the screwdriver 2820 is shown as a Phillips head screwdriver, and screw 2810 is shown as a Phillips head screw, there are various different screws known in the art that have a variety of different types of heads, including slot, Phillips, hex, hex key, torx, etc. The tool 100 may be used to protect wood when any type of screw is being driven.

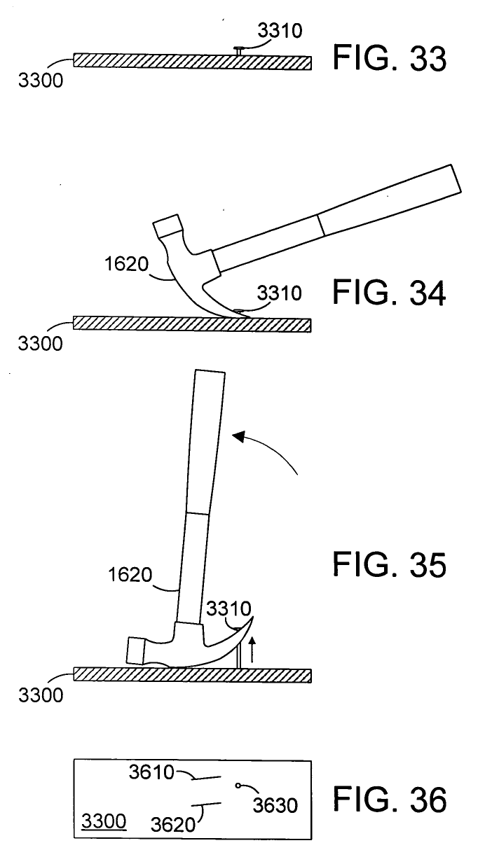

Another known woodworking operation that may result in the marring of wood is the pulling of a nail. Referring to FIG. 33, a piece of wood 3300 includes a nail 3310 that has a head that is above the surface of the piece of wood 3300. A claw hammer may be used to pull the nail as shown in FIG. 34, with the nail head being slipped within the V-slot of the hammer claw, as is known in the art. The hammer handle is then moved as shown in FIG. 35, resulting in the nail 3310 being pulled from the piece of wood 3300. This nail pulling action is possible because of the curved surface of the hammer head contacting the surface of the piece of wood 3300. Ofttimes the pulling of the nail exerts sufficient force on the piece of wood that the hammer head mars the piece of wood. Pulling a nail with a claw hammer may thus produce an indentation in the wood where the head of the hammer pressed when pulling the nail. One example of such an indentation is shown by lines 3610 and 3620 in FIG. 36 that are near the hole 3630 that remains after the nail 3310 is pulled.

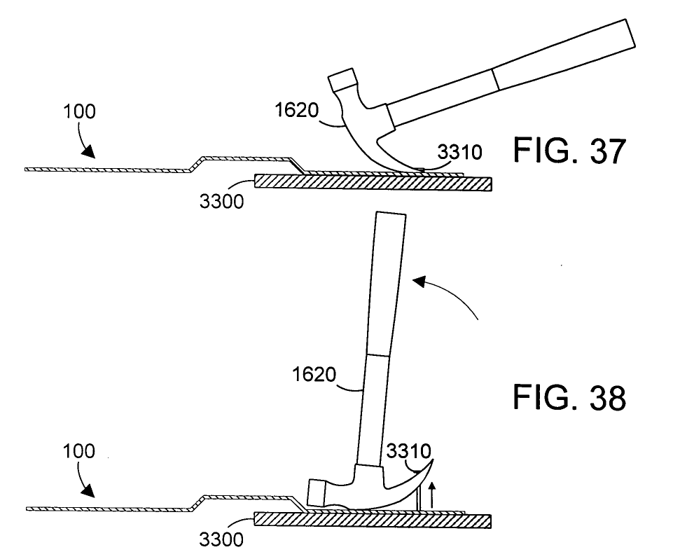

The tool 100 may be used to prevent the head of the hammer 1620 from marring the piece of wood 3300 when a nail is being pulled. FIG. 37 shows the piece of wood 3300 with the tool 100 laid atop the piece of wood to protect an area of wood adjacent the location of the nail 3310. The nail 3310 could pass through a hole in tool 100, could be located within a slot in tool 100, or may be adjacent to an edge of the tool 100. As the nail 3310 is being pulled as shown in FIG. 38, the hammer head contacts the tool 100 instead of contacting the piece of wood 3300. As a result, tool 100 protects the piece of wood 3300 from marring during a nail pulling operation.

The tool is preferably made of a flexible, lightweight material. Examples of suitable materials include wood, sheet metal, and plastic. The most preferred implementation uses a substantially transparent plastic that allows seeing through the tool. One suitable plastic is Lexan, which is very durable and is not likely to break. By making the tool out of plastic, the tool may be manufactured very inexpensively, resulting in a tool that may be inexpensively replaced once worn out. In addition, the tool, if made of plastic, may include inserts that will wear longer than the plastic itself. Thus, one or more holes and one or more slots may include inserts (such as metal) that will protect the plastic from undue wear. Of course, other materials could be used for the tool or the inserts within the scope of the preferred embodiments.

The top surface of the tool is preferably textured so that the lateral motion of a tool that contacts the tool will be slowed by the texture of the tool surface. The texture of the tool surface may be made in any suitable manner. Examples of suitable textures include a pitted surface, a bumped surface, a ribbed surface, a checked surface, etc. Of course, other textures, including a smooth surface, are also within the scope of the preferred embodiments.

The tool may be made in any suitable size and configuration. A small tool that is only a few inches long could be easily carried in a carpenter's tool belt. A larger tool could be carried in a toolbox when protection of a larger area is needed. The tool may also be made to any suitable thickness. A thicker tool provides more stiffness to the tool and allows a larger scraper edge, if needed. In addition, specialized configurations are also within the scope of the preferred embodiments. For example, a stair installer could use a tool that has a configuration that is the size of the most common stair tread. Such a tool could include holes where screws or nails could be placed. Use of such a tool could thus save a stair installer considerable time by automatically marking hole location and protecting the surface of the wood during any woodworking operation.

The preferred embodiments herein discuss the tool in the context of protecting wood during a woodworking operation. One skilled in the art will readily realize that such a tool may be very useful outside of the realm of woodworking. For example, the tool could be used when performing operations on drywall, plastic, metal, or any other suitable material. No limitation to the scope of the claims should be implied simply because the tool is described herein in the context of woodworking operations on a piece of wood.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. A tool comprising:
at least one substantially flat portion including:
at least one slot that opens to an edge of the substantially flat portion; and
at least one hole.

2. The tool of claim 1 wherein the at least one slot is tapered.

3. The tool of claim 1 comprising a plurality of holes.

4. The tool of claim 3 wherein the plurality of holes include holes of different sizes.

5. The tool of claim 1 further comprising a measurement scale near an edge of the tool.

6. The tool of claim 1 further comprising at least one tapered edge.

7. A tool comprising:
a first substantially flat portion;
a second substantially flat portion lying in substantially the same plane as the first portion; and
a connecting portion that connects the first and second portions, the connecting portion extending above the plane of the first and second portions.

8. The tool of claim 7 wherein first portion comprises at least one slot that opens to an edge of the first portion.

9. The tool of claim 8 wherein the first portion further comprises at least one hole.

10. The tool of claim 8 wherein at least one slot is tapered.

11. The tool of claim 7 wherein second portion comprises at least one slot that opens to an edge of the second portion.

12. The tool of claim 11 wherein the second portion further comprises at least one hole.

13. The tool of claim 11 wherein at least one slot is tapered.

14. The tool of claim 11 further comprising a measurement scale near an edge of the tool.

15. The tool of claim 11 further comprising at least one tapered edge.

16. A tool comprising:
a first substantially flat portion, the first portion including at least one tapered slot and at least one hole;
a second substantially flat portion lying in substantially the same plane as the first portion, and second portion including at least one tapered slot and at least one hole; and
a connecting portion that connects the first and second portions, the connecting portion extending above the plane of the first and second portions;
a measurement scale near an edge of the tool;
at least one tapered edge;
wherein the first portion, second portion, and connecting portion are monolithically formed from a substantially transparent plastic.

17. A method for protecting an area of material during an operation, the method comprising the steps of:
positioning a tool in proximity to the operation overlying the area of material, the tool comprising at least one substantially flat portion including at least one opening; and
performing the operation.

18. The method of claim 17 wherein the material comprises wood, and the operation comprises a woodworking operation.

19. The method of claim 17 wherein the operation comprises drilling, and wherein an opening in the tool is positioned over a desired hole location, the step of performing the operation comprising the step of drilling the material through the opening in the tool.

20. The method of claim 17 wherein the operation comprises screwing, and wherein an opening in the tool is positioned over a desired screw location, the step of performing the operation comprising the step of screwing the screw through the opening in the tool.

21. The method of claim 17 wherein the operation comprises nailing, and wherein an opening in the tool is positioned over a desired nail location, the step of performing the operation comprising the step of pounding the nail through the opening in the tool.

22. The method of claim 17 wherein the operation comprises setting a nail, and wherein an opening in the tool is positioned over a nail head, the step of performing the operation comprising the step of pounding the nail head with a nail set with the tool in place.

23. The method of claim 17 wherein the operation comprises pulling a nail, and wherein the tool is positioned near a nail head, the step of performing the operation comprising the step of pulling the nail out of the material in a manner that a nail puller contacts the tool while pulling the nail out of the material.
